(19) United States
(12) Patent Application Publication
(10) Pub. No.: US 2009/0288112 A1
(43) Pub. Date: Nov. 19, 2009

(54) INSERTING ADVANCE CONTENT ALERTS INTO A MEDIA ITEM DURING PLAYBACK

(75) Inventors: Kunal Kandekar, Raleigh, NC (US); Ravi Reddy Katpelly, Durham, NC (US)

Correspondence Address: WITHROW & TERRANOVA CT, 100 REGENCY FOREST DRIVE , SUITE 160, CARY, NC, 27518, US

(73) Assignee: Porto Technology, LLC, Wilmington, DE (US)

(21) Appl. No.: 12/119,638

(22) Filed: May 13, 2008

(51) Int. Cl. H04N 7/10

(52) U.S. Cl. 725/32

(57) ABSTRACT

Systems and methods are disclosed for providing advance content alerts during playback of a media item. In one embodiment, advance content alerts are inserted into the media item during playback. In general, while playing a media item, the media player identifies upcoming content for which the user desires an advance content alert. In response, the media player generates an advance content alert and inserts the advance content alert into the media item during playback. The user may then take an action in response to the advance content alert. In one embodiment, the user may provide input via a remote control of the media player or a mobile device registered with the media player in order to cause a desired action to be taken by the media player in response to the advance content alert.

### FIELD OF THE INVENTION

The present invention relates to providing advance content alerts for upcoming content, such as objectionable content, during playback of a media item.

### BACKGROUND OF THE INVENTION

Typically, at least to some extent, parents wish to control the types of media content that are viewed or listened to by their children. For example, a parent may desire to prevent their children from viewing movies or television programs that contain objectionable content such as violence, nudity, profanity, or the like. However, many times, a parent is caught off-guard. As a result, objectionable content may be viewed or listened to by their children before the parent is aware of the objectionable content. For example, while watching a movie with his children, a father may inadvertently allow the children to hear profanity that he would not have otherwise allowed them to hear. As such, there is a need for a system and method for alerting a person of upcoming objectionable content during playback of a media item.

### SUMMARY OF THE INVENTION

The present invention relates to providing advance content alerts during playback of a media item. In one embodiment, advance content alerts are inserted into the media item during playback. Preferably, the advance content alert inserted into the media item is unobtrusive such that the advance content alert does not affect, or does not substantially affect, the viewing or listening experience of the user and/or other users to which the media item is presented. In operation, while playing a media item, the media player identifies upcoming content for which the user desires an advance content alert. In response, the media player generates an advance content alert and inserts the advance content alert into the media item during playback. For example, the advance content alert may be a graphic, text, or sound that is understood by the user as being an advance content alert. The user may then take an action in response to the advance content alert. In one embodiment, the user may provide input via a remote control of the media player or a mobile device registered with the media player in order to cause a desired action to be taken by the media player in response to the advance content alert.

In another embodiment, in addition to or as an alternative to inserting advance content alerts into the media item during playback, advance content alerts may be provided to a mobile device, such as a mobile telephone, of an associated user. More specifically, a user registers his or her mobile device with a media player and configures the types of content for which the user would like to receive advance content alerts. For example, in the preferred embodiment, the user selects one or more types of content that are objectionable to the user such as violence, profanity, nudity, sexual situations, or the like. Thereafter, during playback of a media item, the media player identifies upcoming content for which the user desires an advance content alert. In response, the media player generates an advance content alert and sends the advance content alert to the mobile device of the user via, for example, a local wireless communication link. The advance content alert may include a preview of the content for which the advance content alert is given, information describing the content for which the advance content alert is given, or the like.

In addition, the advance content alert may give the user a list of one or more actions that can be taken by the user via the mobile device. Then, if desired, the user may select an action to take in response to the advance content alert. In response, the mobile device provides information to the media player instructing the media player to take the desired action. The media player then controls playback of the media item to take the desired action.

Alternatively, the user may select an action to take in response to the advance content alert via a remote control associated with the media player. More specifically, the advance content alert is provided to the mobile device of the user. Again, the advance content alert may include a preview of the content for which the advance content alert is given, information describing the content for which the advance content alert is given, or the like. The user may then take a desired action in response to the advance content alert via the remote control. Note, however, that the advance content alert may include additional information identifying a number of actions that may be taken by the user in response to the advance content alert via the remote control. For example, the advance content alert may include information stating that the user may “bleep out” profane language by pressing a “mute” button on the remote control. The media player may then interpret the “mute” instruction from the remote control as an instruction from the user to “bleep out” the upcoming profane language.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates an advance content alert system for providing advance content alerts to a mobile device of a user according to a first embodiment of the present invention;

FIG. 2 illustrates the operation of the advance content alert system of FIG. 1 according to one embodiment of the present invention;

FIG. 3 illustrates an advance content alert according to one embodiment of the present invention;

FIG. 4 illustrates an advance content alert system for providing advance content alerts to a mobile device of a user according to a second embodiment of the present invention;

FIG. 5 illustrates the operation of the advance content alert system of FIG. 4 according to one embodiment of the present invention;

FIG. 6 illustrates an advance content alert system for providing advance content alerts to a mobile device of a user according to a third embodiment of the present invention;

FIG. 7 illustrates the operation of the advance content alert system of FIG. 6 according to one embodiment of the present invention;

FIG. 8 illustrates an advance content alert system for providing advance content alerts to a mobile device of a user according to a fourth embodiment of the present invention;

FIG. 9 illustrates the operation of the advance content alert system of FIG. 8 according to one embodiment of the present invention;

FIG. 10 is a block diagram of the mobile device of FIGS. 1 and 3 through 9 according to one embodiment of the present invention;

FIG. 11 is a block diagram of the media player of FIGS. 1 and 3 through 9 according to one embodiment of the present invention;

FIG. 12 illustrates an advance content alert system for inserting advance content alerts into a media item during playback according to one embodiment of the present invention;

FIG. 13 illustrates the operation of the advance content alert system of FIG. 12 according to one embodiment of the present invention;

FIG. 14 graphically illustrates an advance content alert and performing a desired action in response to the advance content alert according to one embodiment of the present invention;

FIG. 15 illustrates an advance content alert system for inserting advance content alerts into a media item during playback according to another embodiment of the present invention;

FIG. 16 illustrates the operation of the advance content alert system of FIG. 15 according to one embodiment of the present invention;

FIG. 17 is a block diagram of the mobile device of FIGS. 12 and 13 according to one embodiment of the present invention; and

FIG. 18 is a block diagram of the media player of FIGS. 12, 13, 15 and 16 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

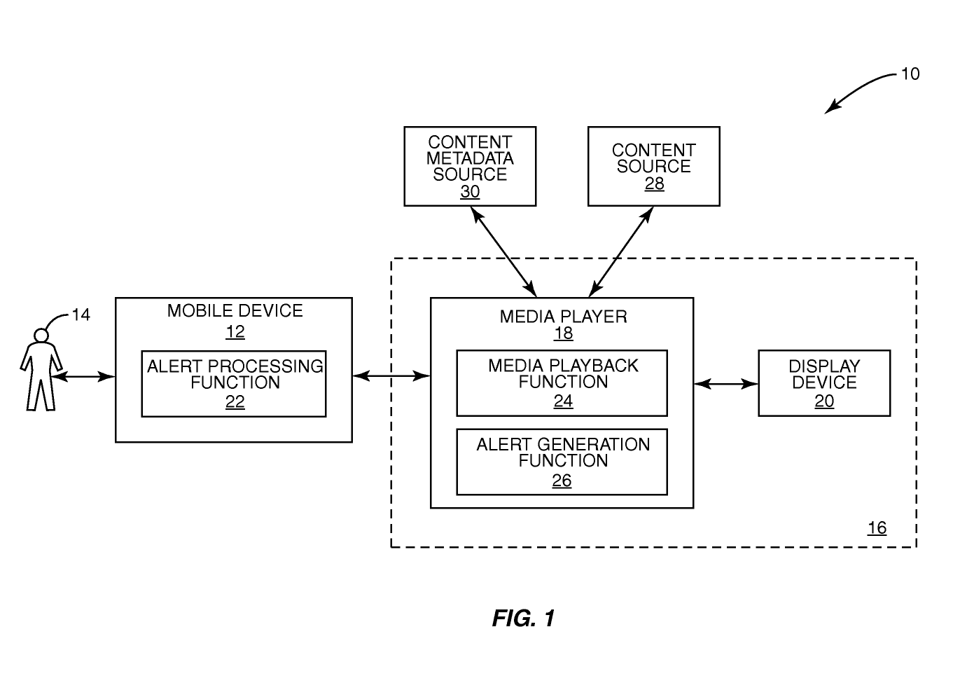

FIG. 1 illustrates an advance content alert system 10 for providing advance content alerts to a mobile device 12 according to one embodiment of the present invention. In general, the advance content alert system 10 includes the mobile device 12 having an associated user 14 and a media playback system 16. In this embodiment, the media playback system 16 includes a media player 18 and a display device 20. The mobile device 12 may be, for example, a mobile telephone such as the Apple® iPhone, a portable media player such as the Apple® iPod® Touch, or the like. The mobile device 12 is preferably connected to the media player 18 via a local wireless connection such as, for example, a Bluetooth® connection, an IEEE 802.11 connection, or the like. However, the mobile device 12 may be connected to the media player 18 via any type of wireless connection provided via any type or combination of Wide Area Network (WAN), Local Area Network (LAN), Personal Area Network (PAN), or the like. In this embodiment, the mobile device 12 includes an alert processing function 22 for processing advance content alerts received from the media player 18, as discussed below. The alert processing function 22 may be implemented in software, hardware, or a combination thereof.

The media player 18 may be, for example, a set-top box (STB) for playing digital television content received from a television content provider, a Digital Video Recorder (DVR) for playing previously recorded video content such as previously recorded television content received from a television content provider, an Apple TV® device for playing downloaded content that has been purchased or rented from a remote media distribution service such as the Apple® iTunes® store, a Digital Versatile Disc (DVD) player, a personal computer, or the like. The media player 18 may be connected to the display device 20 via any desired audio/video connection such as, for example, a High Definition Multimedia Interface (HDMI) connection, a Digital Video Interface (DVI) connection, a coaxial cable connection, or the like. The display device 20 may be, for example, a television. In an alternative embodiment, the display device 20 may be incorporated into the media player 18.

The media player 18 includes a media playback function 24 and an alert generation function 26, each of which may be implemented in software, hardware, or a combination thereof. The media playback function 24 generally operates to provide playback of media items obtained from a content source 28. In the preferred embodiment, the media items are video items. As such, the media playback function 24 provides playback of the video items and presentation of the video items to the user 14 and any other nearby users via the display device 20. The content source 28 varies depending on the particular implementation of the media player 18. For example, if the media player 18 is a STB, then the content source 28 may be a television content distribution network such as a Cable Television (CATV) network. As another example, if the media player 18 is a DVD player, then the content source 28 is a DVD. As a final example, if the media player 18 is a device such as an Apple TV® device, then the content source 28 may be a remote media distribution service such as the Apple® iTunes® store, where the media player 18 has access to the remote media distribution service via a network such as, for example, the Internet.

As discussed below, the alert generation function 26 generally operates to identify content for which advance content alerts are desired by the user 14 and send advance content alerts to the mobile device 12 of the user 14. In one embodiment, either prior to or during playback of a media item, the alert generation function 26 obtains metadata describing media content of the media item from a content metadata source 30 and identifies the content for which advance content alerts are desired by the user 14 based on the metadata. The metadata may be, for example, tags, annotations, a script or lyrics for the media item, closed-captioning information, sub-titles, or the like.

More specifically, in one embodiment, the metadata includes tags directly identifying potentially objectionable content in the media item. The tags may be defined by a producer of the media item, the user 14, or the like. Each tag may be associated with a point in time or a time segment during playback of the media item that includes potentially objectionable content. For example, if the types of objectionable content that may be selected by the user 14 are profane language, violent content, scary content, and sexual situations, the metadata may include tags identifying each occurrence of those types of objectionable content in the media item.

In addition or alternatively, the metadata may include annotations provided by the user 14, other users that have consumed (i.e., viewed, listened to, etc.) the media item, a producer of the media item, or the like. The annotations are generally keywords, comments, or the like associated with a particular point or time segment during playback of the media item. The annotations may be defined by the producer of the media item, the user 14, by a number of users that have previously viewed the media item, or the like. In addition or alternatively, the metadata may include a script for the media item if the media item is a video item such as a movie or television program, lyrics if the media item is a song, closed-captioning information if the media item is broadcast television content, or subtitles if the media item is a video item such as a movie.

The content metadata source 30 may vary depending on the particular implementation. In one embodiment, if the media item is provided according to a standard allowing for annotations such as MPEG-7, the content metadata source 30 may be the same as that of the media item where the annotations are provided in connection with the media item according to the standard. Similarly, if the media item has closed-captioning or subtitles, the content metadata source 30 may be the same as that of the media item. Alternatively, the content metadata source 30 may be a remote server storing metadata for a number of media items, where the alert generation function 26 queries the remote server to obtain the metadata for the media item. Note, however, that the content metadata source 30 may be any source of metadata that may be used to directly or indirectly detect content in the media item for which the user 14 desires an advance content alert.

The present invention is not limited to detecting content for which the user 14 desires advance content alerts based on metadata for the media item. For example, rather than identifying the content for which the advanced content alerts are desired based on metadata for the media item, the alert generation function 26 may analyze the media item itself to identify the content for which the advance content alerts are desired. For instance, if advance content alerts are desired for profane language and the media item is a video or song, the alert generation function 26 may utilize audio analysis techniques to identify profane language in the media item. More specifically, the alert generation function 26 may perform speech-to-text conversion and then compare the text to a list of profane language terms or phrases in order to identify profane language in the media item. In a similar manner, if advance content alerts are desired for violent content and the media item is a video such as a movie, the alert generation function 26 may utilize frame analysis techniques to identify frames or segments of the media item containing violence.

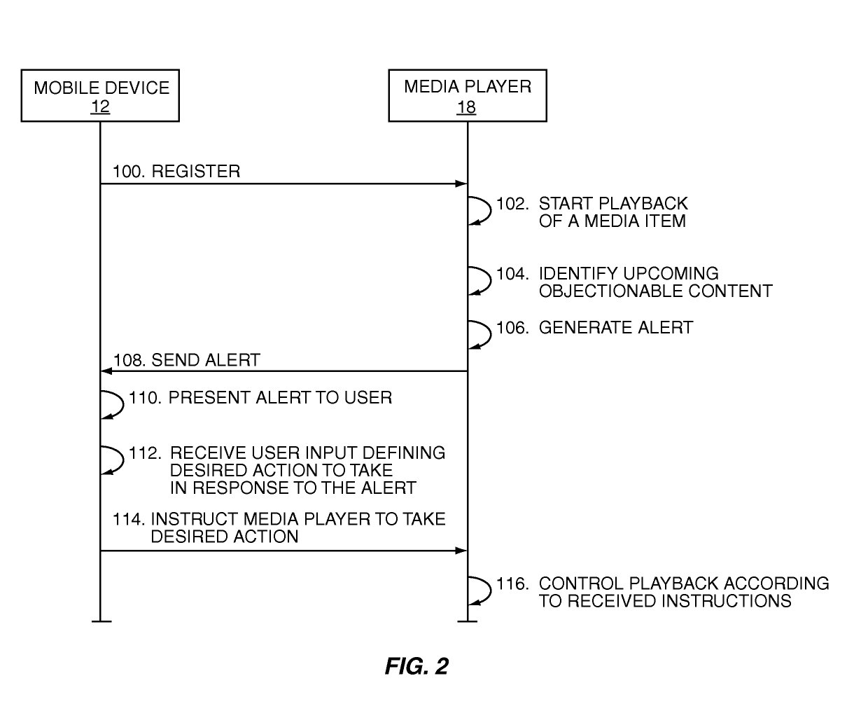

FIG. 2 illustrates the operation of the advance content alert system 10 of FIG. 1 according to one embodiment of the present invention. First, the mobile device 12 registers with the media player 18 (step 100). During registration, communication between the mobile device 12 and the media player 18 is established. In addition, the user 14 of the mobile device 12 may be enabled to provide personalized configurations for advance content alerts to be provided to the mobile device 12 of the user 14. The personalized configurations may include types of content for which the user 14 desires to receive advance content alerts. In the preferred embodiment, the types of content for which the user 14 desires to receive advance content alerts includes one or more types of objectionable content such as, for example, profane language, violent content, scary content, sexual situations, or the like. As such, hereinafter, the content for which the user 14 desires to receive advance content alerts is referred to as objectionable content. However, the present invention is not limited to providing advance content alerts for objectionable content. The advance content alerts may additionally or alternatively be provided for other types of content such as, for example, desirable content. For example, if the user 14 likes or desires action scenes, advance content alerts may be provided to the user 14 for action scenes.

In one embodiment, the user 14 is enabled to select one or more types of objectionable content for which to receive advance content alerts from a list of predefined objectionable content types such as, for example, profane language, violent content, scary content, sexual situations, or the like. In addition or alternatively, the user 14 may be enabled to define customized objectionable content types by, for example, entering one or more keywords, selecting one or more keywords from a list of predefined keywords, or the like. In an alternative embodiment, the types of objectionable content may be predefined and non-configurable by the user 14. In addition to defining the types of objectionable content, the personalized configurations of the user 14 may define desired attributes of the advance content alerts. The desired attributes may include, for example, an amount of time between when an advance content alert is to be provided to the mobile device 12 and playback of the objectionable content. The desired attributes may also include attributes defining information to be provided in the advance content alerts such as a preview of the objectionable content, information describing or identifying the objectionable content, or the like.

The personalized configurations may also include configurations defining when advance content alerts are to be provided to the mobile device 12. More specifically, the personalized configurations may define a time period during the day when the advance content alerts are or are not to be provided, one or more days of the week on which the advance content alerts are or are not to be provided, or the like. For example, the personalized configurations may be defined such that advance content alerts are provided to the mobile device 12 of the user 14 only during the hours of 5 PM to 9 PM when it is likely that the user 14 and his children will be viewing or listening to media items played by the media player 18. The personalized configurations may also be defined such that the advance content alerts are only to be provided to the mobile device 12 when another defined user, or mobile device of another defined user, is nearby, such as within a local wireless communication range of the media player 18. For example, the user 14 may register a mobile device of his child with the media player 18 and define his personalized configurations such that advance content alerts are provided to the mobile device 12 only when the mobile device of his child is within a local wireless communication range of the media player 18. Still further, the personalized configurations may include configurations defining an amount of time that the alert generation function 26 is to look ahead into the media item to look for objectionable content. For example, the personalized configurations may state that the media player 12 is to look ahead ten (10) minutes for upcoming content for which the user 14 desires advance content alerts.

The personalized configurations may also define default actions to take in response to advance content alerts for one or more of the defined types of objectionable content for which the user 14 desires advance content alerts. The default actions may be taken when, for example, the user 14 does not respond to an advance content alert, when the media player 18 is unable to communicate with the mobile device 12 such as when the mobile device 12 is out of a local wireless communication range of the media player 18, or the like.

In this embodiment, the media player 18 then begins playback of a media item (step 102). The media item is preferably a video item such as a television program, movie, or the like. However, the media item may alternatively be an audio item such as a song, audio book, radio broadcast, podcast, or the like. Next, the media player 18, and more specifically the alert generation function 26, identifies upcoming objectionable content (step 104). More specifically, in one embodiment, the alert generation function 26 obtains metadata for the media item from the content metadata source 30 and processes the metadata to identify upcoming objectionable content as defined by the personalized configurations of the user 14.

In one embodiment, the metadata for the media item includes tags identifying potentially objectionable content in the media item. Each tag may identify the type of potentially objectionable content and a time or time range in playback of the media item at which the potentially objectionable content is located. As such, the alert generation function 26 may identify the objectionable content by identifying the tags for the one or more types of objectionable content identified in the personalized configurations of the user 14. For example, the potential objectionable content types may include profane language, violent content, scary content, and sexual situations, and the user 14 may define his personalized configurations such that advance content alerts are to be provided to the mobile device 12 of the user 14 for violent content and sexual situations. As such, when identifying upcoming objectionable content, the alert generation function 26 may utilize the tags for violent content and sexual situations but ignore tags for profane language and scary content.

In another embodiment, the metadata for the media item includes annotations such as keywords or comments provided by a producer of the media item, provided by the user 14, or collaboratively provided by a number of users that have previously consumed the media item. Each annotation is preferably linked to a particular point in time or time range in playback of the media item. In this embodiment, the alert generation function 26 processes the annotations to determine whether the annotations indicate that objectionable content is present at the corresponding points in time or time ranges in playback of the media item. More specifically, for each type of objectionable content, a number of related keywords or phrases may be defined. The alert generation function 26 may then search the annotations for words or phrases that match those defined for the types of objectionable content for which advance content alerts are desired in order to identify upcoming objectionable content. For example, if the user 14 is to receive advance content alerts for violent content, the alert generation function 26 may search the annotations for a number of predefined keywords such as kill, death, shoot, gun, and the like. Thus, if an annotation reads: “Jason Bourne kills . . . ,” then the alert generation function 26 identifies the corresponding point in time or time range during playback of the media item as containing violent content. The related keywords or phrases defined for each type of objectionable content may be predefined and not configurable by the user 14, predefined but configurable by the user 14, defined by the user 14, or the like and may be stored in any desired data structure locally at the media player 18 or in a remote database accessible to the media player 18.

In yet another embodiment, the metadata may include information such as a script if the media item is a video item such as a movie or television program or lyrics if the media item is a song. The alert generation function 26 may process this information in a manner similar to the annotations discussed above. More specifically, for each type of objectionable content, a number of related keywords or phrases may be defined. The alert generation function 26 may then process the script or lyrics to identify words or phrases that match those related to the objection content in order to identify objectionable content in the media item. Note that, in this embodiment, the metadata may include timing information for synchronizing the script or lyrics to the media item. Alternatively, the media player 18 may perform speech-to-text conversion on the audio component of the media item in order to synchronize the media item with the script or lyrics. In a similar manner, other types of metadata such as closed-captioning information, subtitles, or the like may be used by the alert generation function 26.

Again, as discussed above, the manner in which the metadata for the media item is obtained may vary depending on the particular implementation. The metadata may be provided to the media player 18 in association with the media item. Alternatively, the metadata may be obtained from a remote source such as a remote server storing metadata for a number of media items including the media item. Also, as discussed above, the present invention is not limited to identifying objectionable content in the media item based on metadata for the media item. For example, as discussed above with respect to FIG. 1, rather than identifying the objectionable content based on metadata for the media item, the alert generation function 26 may analyze the media item itself using known audio and/or video analysis techniques to identify the content for which the advance content alerts are desired.

After identifying upcoming objectionable content, the alert generation function 26 generates an advance content alert for the upcoming objectionable content (step 106). The advance content alert may be generated to include a preview of the objectionable content, information describing the objectionable content, or the like. For example, if the objectionable content is violence and the media item is a video, a preview of the video including all or a portion of the violent content may be generated and included in the advance content alert. In addition or alternatively, the advance content alert may include all or a portion of any annotation for the upcoming objectionable content, information identifying the objectionable content as violent content, a count-down timer indicating an amount of time, such as a number of seconds, until playback of the upcoming objectionable content, or the like.

If the user 14 has defined personalized configurations defining desired attributes of advance content alerts, the media player 18 generates the advance content alert for the upcoming objectionable content according to those desired attributes. For example, if the user 14 desires that a preview of the objectionable content be provided in the advance content alert, the media player 18 generates a preview of the objectionable content to include in the advance content alert. Also, if the user 14 desires that the advance content alert be given a defined amount of time before the objectionable content is to be played, the media player 18 generates the advance content alert at a time that will enable the advance content alert to be sent to the mobile device 12 at the desired time.

The advance content alert may also include a list of one or more actions that can be taken by the user 14 in response to the advance content alert. More specifically, if the objectionable content is profane language, the advance content alert may provide the user 14 with the option of “bleeping out” the profane language, muting the media item during the profane language, replacing the profane language with substitute language, or the like. Note that the synchronization of these desired actions to the profane language is provided by the metadata. Likewise, if the media item is a video and the objectionable content is a segment of the video including violence, nudity, or the like, the advance content alert may provide the user 14 with the option of skipping the objectionable content, skipping ahead to a frame that is most similar to a frame at or prior to the beginning of the objectionable content, or replacing the objectionable content with an advertisement. When skipping the objectionable content, the media player 18 may provide for skipping a predefined amount of time. Alternatively, the metadata may be used to identify the beginning and end of the objectionable content such that the user 14 is enabled to skip from the start of the objectionable content to the end of the objectionable content. As for skipping to the next most similar frame, the media player 18 may perform frame analysis to identify a next most similar frame to a frame at the beginning of or prior to the objectionable content. The user 14 may then be enabled to skip from the frame at the beginning of or prior to the objectionable content to the next most similar frame.

After generating the advance content alert, the media player 18, and more specifically the alert generation function 26, sends the advance content alert for the upcoming objectionable content to the mobile device 12 of the user 14 (step 108). Note that if the personalized configurations of the user 14 indicate that the user 14 desires advance content alerts to be provided to the mobile device 12 a defined amount of time before the objectionable content is to occur, then the alert generation function 26 operates to send the advance content alert to the mobile device 12 at the desired time.

Note that prior to identifying the upcoming objectionable content or at some point before generating and sending the advance content alert to the mobile device 12, the alert generation function 26 may determine whether advance content alerts are desired by the user 14 at this time based on the personalized configurations of the user 14. For example, if the personalized configurations state that advance content alerts are only to be provided between 5 PM and 7 PM and the current time of day is 3 PM, then no advance content alert is provided. Similarly, if the personalized configurations state that advance content alerts are to be given only if a particular person, or mobile device of a particular person, is present or near the media player 18, then the alert generation function 26 may determine whether the required person, or the mobile device of the required person, is present or nearby before providing advance content alerts. Similarly, advance content alerts may be given if a particular person, or a mobile device of the particular person, is absent or not near the media player 18.

Upon receiving the advance content alert, the alert processing function 22 of the mobile device 12 presents the advance content alert to the user 14 (step 110). Preferably, the advance content alert is presented to the user 14 via a display of the mobile device 12. However, the advance content alert may alternatively be an audible alert, a vibration alert, or the like, in which case the alert processing function 22 operates to present the advance content alert to the user 14 accordingly. Next, in this embodiment, the alert processing function 22 of the mobile device 12 receives user input from the user 14 defining a desired action to take in response to the advance content alert (step 112). As discussed above, in one embodiment, the advance content alert may include a list of actions that can be taken by the user 14. As such, the user input may be the selection of one of the actions by the user 14 as the desired action to take in response to the advance content alert. In another embodiment, if the user 14 desires to skip over the objectionable content, the alert processing function 22 may enable the user 14 to define a segment of the media item to skip while viewing or listening to a preview of the objectionable content in the media. More specifically, while viewing or listening to the preview of the media item including the objectionable content, the user 14 may be enabled to select a starting point and an ending point for a segment of the media item to be skipped. In yet another embodiment, the alert processing function 22 may enable the user 14 to perform traditional remote control functions such as muting, fast-forwarding, and the like such that the user 14 may mute playback of the media item during the objectionable content, fast-forward playback of the media item through the objectionable content, or the like.

Upon receiving the user input from the user 14, the mobile device 12 instructs the media player 18 to perform the desired action (step 114). In response, the media player 18, and more specifically the media playback function 24 of the media player 18, controls playback of the media item according to the received instructions such that the desired action is taken (step 116).

Note that rather than selecting an action to take in response to the advance content alert, the user 14 may indicate that the objectionable content identified by the advance content alert is not in fact objectionable, is not to be considered objectionable for the current playback session, is not to be considered objectionable for a defined amount of time, or the like. This information may be provided as feedback to the alert generation function 26, which may then utilize this information when identifying upcoming objectionable content. For example, if the user 14 indicates that the objectionable content is not in fact objectionable, then the alert generation function 26 may thereafter determine that similar content of the media item is also not objectionable.

It should also be noted that for certain types of content metadata sources 30 and content sources 28, it may be desirable to buffer the media item such that the alert generation function 26 is enabled to detect the objectionable content and send the advance content alert to the mobile device 12 prior to the occurrence of the objectionable content. For example, if the content source 28 is a remote server streaming the media item to the media player 18 in the MPEG-4 format, the metadata to be used to detect upcoming objectionable content may be annotations provided according to the MPEG-7 standard, which are delivered simultaneously with the streaming media content. As such, the media player 18 may buffer the streaming media item an amount of time that is sufficient to enable the alert generation function 26 to detect the upcoming objectionable content, send the advance content alert to the mobile device 12, and allow the user 14 to take a desired action. As another example, if the media item is a broadcast television program and the metadata is associated closed-captioning information, the media player 18 may buffer the media item and close-captioning information such that presentation of the media item is delayed by an amount of time that is sufficient to allow detection of the upcoming objectionable content, generation and sending of the advance content alert, and selection of a desired action to take in response to the advance content alert by the user 14.

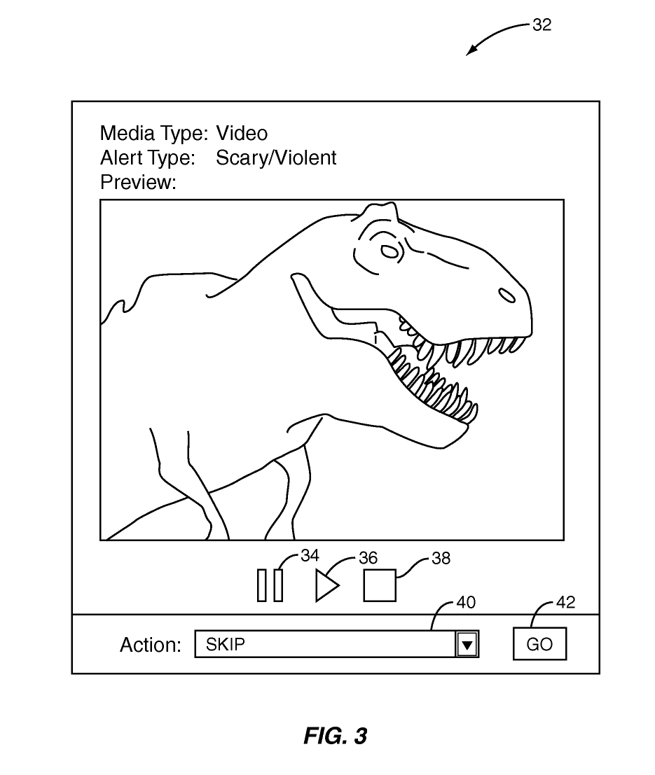

FIG. 3 illustrates an exemplary Graphical User Interface (GUI) 32 used by the alert processing function 22 to present an advance content alert to the user 14 according to one embodiment of the present invention. In general, the GUI 32 identifies a type of the media item being played by the media player 18, which in this example is video. Note that as will be apparent to one of ordinary skill in the art, as used herein, a video item preferably includes both audio and video content. The GUI 32 also identifies the type of objectionable content triggering the advance content alert. In this example, the triggering objectionable content for the advance content alert is scary/violent content. The GUI 32 also presents a preview of the objectionable content from the media item to the user 14. Controls 34, 36, and 38 enable the user 14 to control playback of the preview at the mobile device 12. Lastly, the GUI 32 includes a pull-down menu 40 enabling the user 14 to select a desired action to take in response to the advance content alert from a number of predetermined actions. Note that the pull-down menu 40 is exemplary and is not intended to limit the scope of the present invention. The pull-down menu 40 may be initialized to an initial selection based on the type of objectionable content identified in the advance content alert and/or actions listed in the pull-down menu 40 may be selected or otherwise provided to correspond to the type of objectionable content.

Once the user 14 has selected a desired action to take from the pull-down menu 40, the user 14 may cause the desired action to be taken by selecting a “Go” button 42. In response to the user 14 selecting the “Go” button 42, the alert processing function 22 of the mobile device 12 sends instructions to the media player 18 to take the desired action selected by the user 14 from the pull-down menu 40. Note that the GUI 32 is exemplary and is not intended to limit the scope of the present invention. Numerous variations will be apparent to one of ordinary skill in the art upon reading this disclosure.

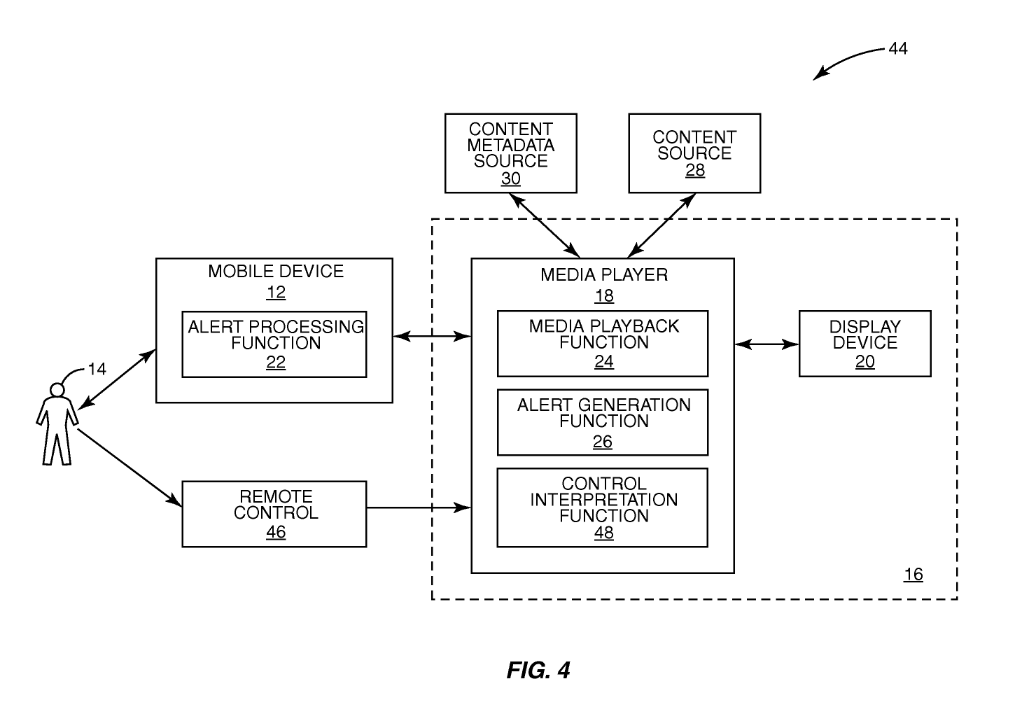

FIG. 4 illustrates an advance content alert system 44 according to a second embodiment of the present invention. The advance content alert system 44 is substantially similar to the advance content alert system 10 of FIGS. 1 and 2. However, in the advance content alert system 44, the user 14 takes a desired action in response to an advance content alert via a remote control 46 associated with the media player 18 rather than the mobile device 12. In addition, in this embodiment, the media player 18 may include a control interpretation function 48 for interpreting instructions from the remote control 46 in light of a prior advance content alert provided to the mobile device 12, as discussed below.

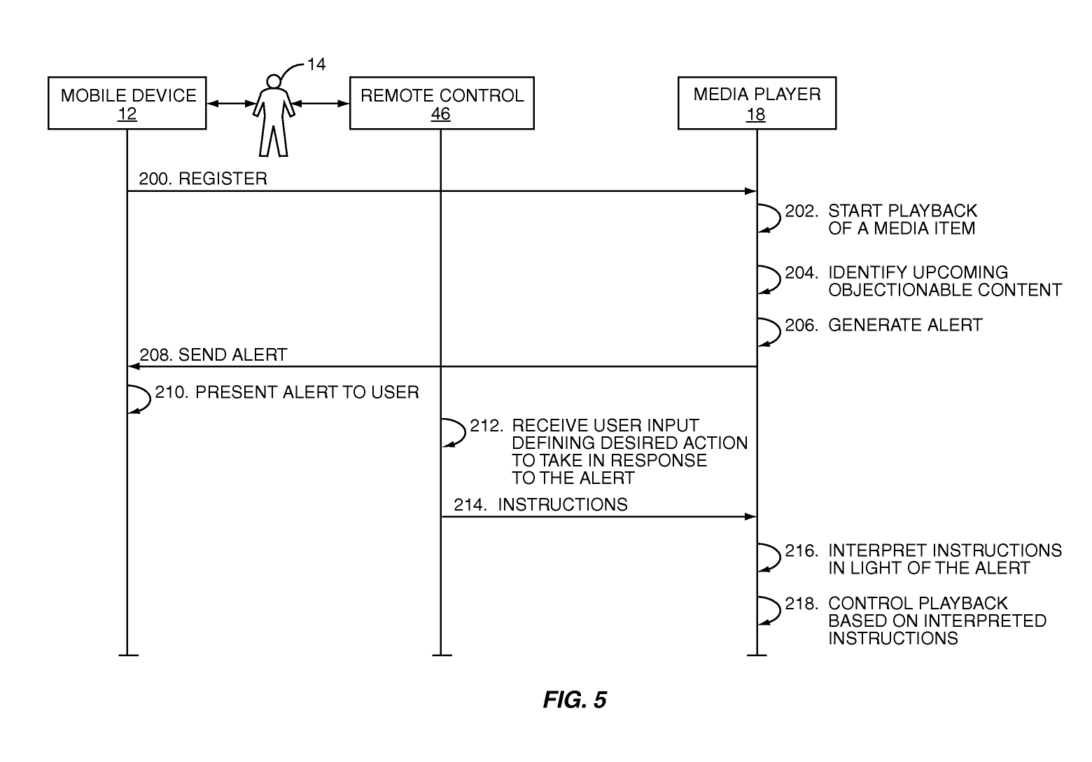

FIG. 5 illustrates the operation of the advance content alert system 44 of FIG. 4 according to one embodiment of the present invention. First, the mobile device 12 registers with the media player 18 (step 200). During registration, communication between the mobile device 12 and the media player 18 is established. In addition, as discussed above, the user 14 of the mobile device 12 may be enabled to provide personalized configurations for advance content alerts to be provided to the mobile device 12 of the user 14.

In this embodiment, the media player 18 then begins playback of a media item (step 202). The media item is preferably a video item such as a television program, movie, or the like. However, the media item may alternatively be an audio item such as a song, audio book, radio broadcast, podcast, or the like. Next, the media player 18, and more specifically the alert generation function 26, identifies upcoming objectionable content (step 204). As discussed above, in one embodiment, the alert generation function 26 obtains metadata for the media item from the content metadata source 30 and processes the metadata to identify upcoming objectionable content as defined by the personalized configurations of the user 14. Again, as discussed above, the manner in which the metadata for the media item is obtained may vary depending on the particular implementation. Also, note that the present invention is not limited to identifying objectionable content in the media item based on metadata for the media item. For example, as discussed above with respect to FIG. 1, rather than identifying the objectionable content based on metadata for the media item, the alert generation function 26 may analyze the media item itself to identify the content for which the advance content alerts are desired.

After identifying upcoming objectionable content, the alert generation function 26 generates an advance content alert for the upcoming objectionable content (step 206). The advance content alert may be generated to include a preview of the objectionable content, information describing the objectionable content, or the like. For example, if the objectionable content is violence and the media item is a video, a preview of the video including all or a portion of the violent content may be generated and included in the advance content alert. In addition or alternatively, the advance content alert may include all or a portion of any annotation for the upcoming objectionable content, information identifying the objectionable content as violent content, a count-down timer indicating an amount of time, such as a number of seconds, until playback of the upcoming objectionable content, or the like.

If the user 14 has defined personalized configurations defining desired attributes of advance content alerts, the media player 18 generates the advance content alert for the upcoming objectionable content according to those desired attributes. For example, if the user 14 desires that a preview of the objectionable content be provided in the advance content alert, the media player 18 generates a preview of the objectionable content to include in the advance content alert. Also, if the user 14 desires that the advance content alert be given a defined amount of time before the objectionable content is to be played, the media player 18 generates the advance content alert at a time that will enable the advance content alert to be sent to the mobile device 12 at the desired time.

In addition, if control interpretation is performed by the media player 18, the advance content alert may also include information defining a number of actions that may be taken by the user 14 in response to the advance content alert via the remote control 46. More specifically, if the objectionable content is profane language, the advance content alert may inform the user 14 that the user 14 may cause the profane language to be “bleeped out,” muted, replaced with substitute language, or the like by pressing indicated buttons on the remote control 46. For example, the advance content alert may indicate that the user 14 may “bleep out” the profane language by pressing a number “1” on the remote control 46, mute the profane language by pressing a number “2” on the remote control 46, or replace the profane language with substitute words by pressing a number “3” on the remote control 46. Likewise, if the media item is a video and the objectionable content is a segment of the video including violence, nudity, or the like, the advance content alert may inform the user 14 that the user 14 may cause skipping of the objectionable content, skipping to a next most similar frame, or replacing the objectionable content with an advertisement by pressing corresponding buttons on the remote control 46.

After generating the advance content alert, the media player 18, and more specifically the alert generation function 26, sends the advance content alert for the upcoming objectionable content to the mobile device 12 of the user 14 (step 208). Note that if the personalized configurations of the user 14 indicate that the user 14 desires advance content alerts to be provided to the mobile device 12 a defined amount of time before the objectionable content is to occur, then the alert generation function 26 operates to send the advance content alert to the mobile device 12 at the desired time. Upon receiving the advance content alert, the alert processing function 22 of the mobile device 12 presents the advance content alert to the user 14 (step 210). Preferably, the advance content alert is presented to the user 14 via a display of the mobile device 12. However, the advance content alert may alternatively be an audible alert, a vibration alert, or the like, in which case the alert processing function 22 operates to present the advance content alert to the user 14 accordingly.

Next, the remote control 46 receives user input from the user 14 defining a desired action to take in response to the advance content alert (step 212). As discussed above, in one embodiment, the advance content alert may include information informing the user 14 of actions that may be taken and corresponding buttons that may be pressed on the remote control 46 to select one of the actions to be taken. However, the present invention is not limited thereto. Upon receiving the user input from the user 14, the remote control 46 sends corresponding instructions to the media player 18 (step 214). Optionally, the control interpretation function 48 interprets the instructions from the remote control 46 in light of the advance content alert sent to the mobile device 12 (step 216). Using the example given above for profane language, the user may press the number “2” on the remote control 46 in order to instruct the media player 18 to mute the profane language. As such, the control interpretation function 48 interprets instructions, which may simply be a signal, from the remote control 46 indicating that the number “2” has been pressed as instructions to mute the upcoming profane language. Note that instructions in the advance content alert are not necessary for control interpretations. For example, a mute command from the remote control 46 may be interpreted as an instruction to “bleep out,” mute, or replace profane language. The media playback function 24 of the media player 18 then controls playback of the media item according to the interpreted instructions from the remote control 46, or alternatively non-interpreted instructions from the remote control 46, such that the desired action selected by the user 14 is taken (step 218).

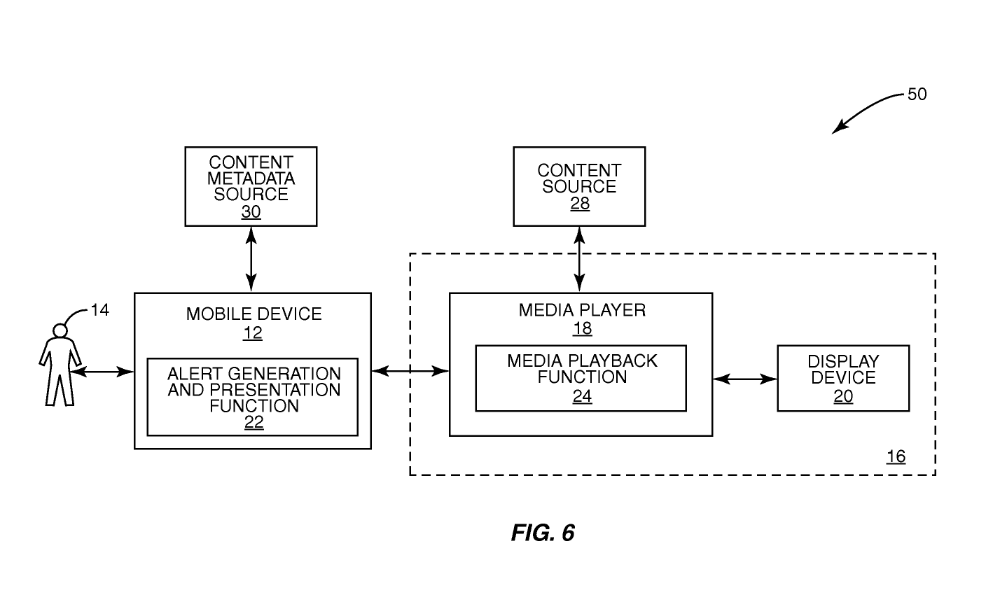

FIG. 6 illustrates an advance content alert system 50 according to a third embodiment of the present invention. The advance content alert system 50 is substantially similar to the advance content alert systems 10 and 44 discussed above. However, in the advance content alert system 50, the mobile device 12, rather than the media player 18, operates to identify upcoming objectionable content. More specifically, in this embodiment, the mobile device 12 includes an alert generation and presentation function 52 which operates to identify upcoming objectionable content in a media item played by the media player 18. In response, the alert generation and presentation function 52 generates and presents an advance content alert to the user 14 of the mobile device 12. In addition, the alert generation and presentation function 52 may enable the user 14 to take a desired action in response to the advance content alert.

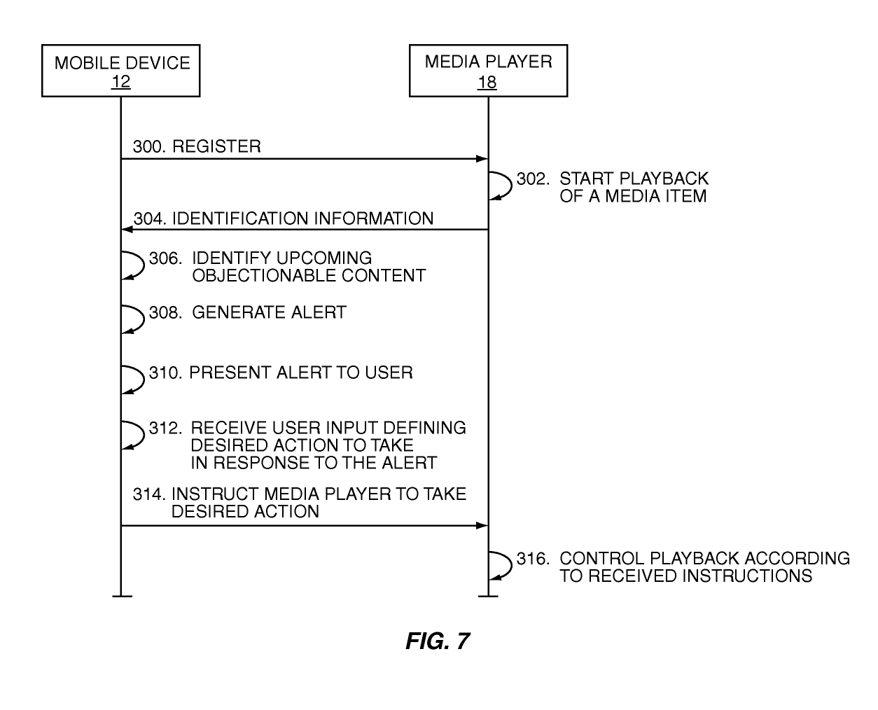

FIG. 7 illustrates the operation of the advance content alert system 50 of FIG. 6 according to one embodiment of the present invention. First, the mobile device 12 registers with the media player 18 (step 300). During registration, communication between the mobile device 12 and the media player 18 is established. Note that the user 14 may define personalized configurations in much the same manner as described above. However, in this embodiment, the personalized configurations are stored and utilized at the mobile device 12.

In this embodiment, the media player 18 then begins playback of a media item (step 302). The media item is preferably a video item such as a television program, movie, or the like. However, the media item may alternatively be an audio item such as a song, audio book, radio broadcast, podcast, or the like. Sometime either prior to or during playback of the media item, the media player 18 provides information identifying the media item to the mobile device 12 (step 304). In one embodiment, the information identifying the media item may be an Identifier (ID) of the media item such as a Globally Unique ID (GUID), a title of the media item, or the like. In another embodiment, the information identifying the media item is output audio and/or video content resulting from playback of the media item, where the alert generation and presentation function 52 operates to identify the media item using frame recognition techniques, speech-to-text techniques, or the like. For example, the alert generation and presentation function 52 may capture the audio output of the display device 20 resulting from playback of the media item and perform speech-to-text conversion to convert the audio output to text. The alert generation and presentation function 52 may then provide the text to a remote source, such as the content metadata source 30, in order to identify the media item based on the text. As another example, the alert generation and presentation function 52 may capture the audio output of the display device resulting from playback of the media item, and generate an audio fingerprint of the media item, where a remote source such as the content metadata source 30 then identifies the media item based on the audio fingerprint. As a final example, the alert generation and presentation function 52 may capture audio and/or video output of the display device 20 resulting from playback of the media item and provide the captured audio and/or video to a remote source, such as the content metadata source 30, for identification of the media item. Note that the media item may be identified in any desired manner by the media player 18, the mobile device 12, or some remote source based on information from the media player 18 or the mobile device 12. The present invention is not limited by the examples given above.

In addition to the identification information, the media player 18 may provide timing information to the mobile device 12 identifying a playback location within the media item. For example, the timing information may indicate that playback is currently at XX minutes, YY seconds, and ZZ milliseconds. The timing information may be periodically provided to the mobile device 12 during playback. Alternatively, rather than periodically providing the timing information, the media player 18 may provide initial timing information to the mobile device 12 to provide initial synchronization and thereafter provide playback control events such as pause events, fast-forward events, and the like to the mobile device 12 such that synchronization is maintained. Rather than receiving timing information from the media player 18, the mobile device 12 may capture audio and/or video output of the display device 20 resulting from playback of the media item. The position in playback of the media item may then be determined by the mobile device 12 or some remote system based on the captured audio and/or video output.

The alert generation and presentation function 52 of the mobile device 12 then identifies upcoming objectionable content (step 306). In one embodiment, once the media item is identified based on the identification information, the alert generation and presentation function 52 obtains metadata for the media item from the content metadata source 30 and processes the metadata to identify upcoming objectionable content as defined by the personalized configurations of the user 14. In this embodiment, the content metadata source 30 is preferably a remote server. However, the present invention is not limited thereto. Note that the alert generation and presentation function 52 may alternatively provide the identification information to the content metadata source 30, where the content metadata source 30 identifies the media item and returns the metadata for the media item to the alert generation and presentation function 52. The manner in which the alert generation and presentation function 52 identifies upcoming objectionable content based on the metadata for the media item is the same as discussed above with respect to the alert generation function 26 and, as such, the details are not repeated.

After identifying upcoming objectionable content, the alert generation and presentation function 52 generates an advance content alert for the upcoming objectionable content (step 308). The advance content alert may be generated to include information describing the objectionable content or the like. In addition, a preview of the objectionable content may be obtained from the media player 18 or a remote source such as, for example, a media distribution service. For example, if the objectionable content is violence and the media item is a video, a preview of the video including all or a portion of the violent content may be obtained and included in the advance content alert. In addition or alternatively, the advance content alert may include all or a portion of any annotation for the upcoming objectionable content, information identifying the objectionable content as violent content, a count-down timer indicating an amount of time, such as a number of seconds, until playback of the upcoming objectionable content, or the like.

If the user 14 has defined personalized configurations defining desired attributes of advance content alerts, the alert generation and presentation function 52 generates the advance content alert for the upcoming objectionable content according to those desired attributes. For example, if the user 14 desires that the advance content alert be given a defined amount of time before the objectionable content is to be played, the alert generation and presentation function 52 generates the advance content alert at a time that will enable the advance content alert to be presented to the user 14 at the mobile device 12 at the desired time.

In addition, the advance content alert may include a list of one or more actions that may be taken by the user 14 in response to the advance content alert. For example, if the objectionable content is profane language, the advance content alert may give the user 14 the option to mute playback during the profane language. Note that the metadata preferably indicates the time in playback at which the profane language occurs. Further, since the alert generation and presentation function 52 preferably knows the current time in the playback of the media item by the media player 18, the alert generation and presentation function 52 may provide a mute instruction to the media player 18 at the beginning of or just prior to the profane language and follow up with an un-mute instruction after the profane language has ended. The alert generation and presentation function 52 may provide for skipping of objectionable content such as violent video content in a similar manner.

After generating the advance content alert, the alert generation and presentation function 52 presents the advance content alert to the user 14 at the mobile device 12 (step 310). Preferably, the advance content alert is presented to the user 14 via a display of the mobile device 12. However, the advance content alert may alternatively be an audible alert, a vibration alert, or the like, in which case the alert processing function 22 operates to present the advance content alert to the user 14 accordingly. Further, if the personalized configurations of the user 14 define a desired amount of time prior to the objectionable content that the advance content alert is to be presented, the alert generation and presentation function 52 presents the advance content alert at the desired time.

Next, in this embodiment, the alert generation and presentation function 52 of the mobile device 12 receives user input from the user 14 defining a desired action to take in response to the advance content alert (step 312). As discussed above, in one embodiment, the advance content alert may include a list of actions that may be taken by the user 14. As such, the user input may select one of those actions as the desired action to be taken. Alternatively, the mobile device 12 may enable traditional remote control functionality such as muting, fast-forwarding, or the like. If so, the user 14 may provide input instructing the mobile device 12 to cause the media player 18 to mute playback, fast-forward playback, or the like. Upon receiving the user input from the user 14, the alert generation and presentation function 52 of the mobile device 12 sends corresponding instructions to the media player 18 (step 314). The media playback function 24 of the media player 18 then controls playback of the media item according to the instructions from the mobile device 12 such that the desired action selected by the user 14 is taken (step 316).

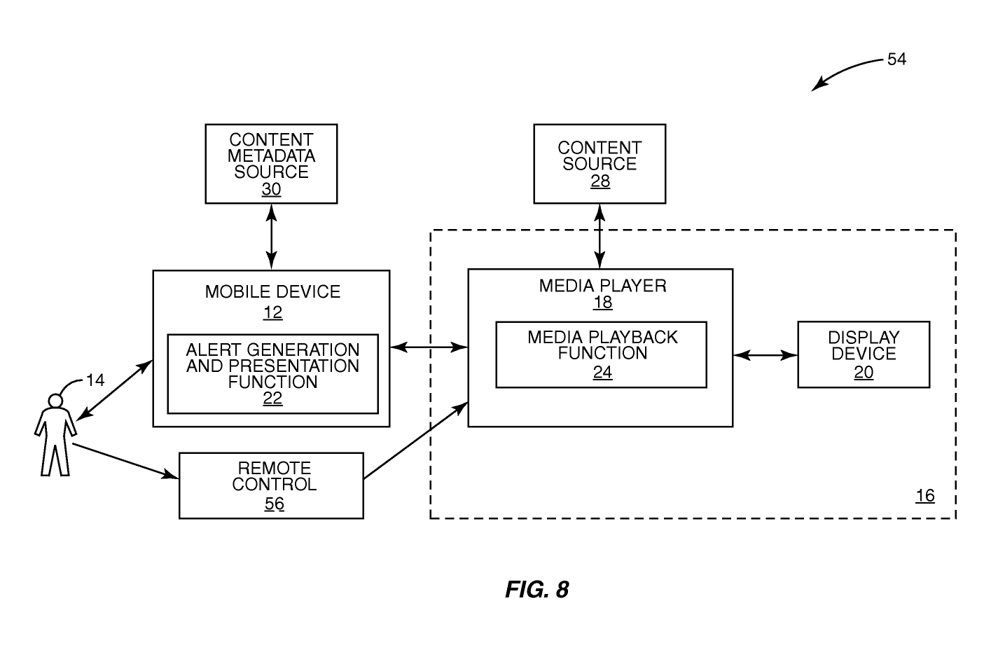

FIG. 8 illustrates an advance content alert system 54 according to a fourth embodiment of the present invention. The advance content alert system 54 is substantially similar to the advance content alert system 50 of FIG. 6. However, in the advance content alert system 54, the user 14 takes a desired action in response to an advance content alert via a remote control 56 associated with the media player 18 rather than the mobile device 12.

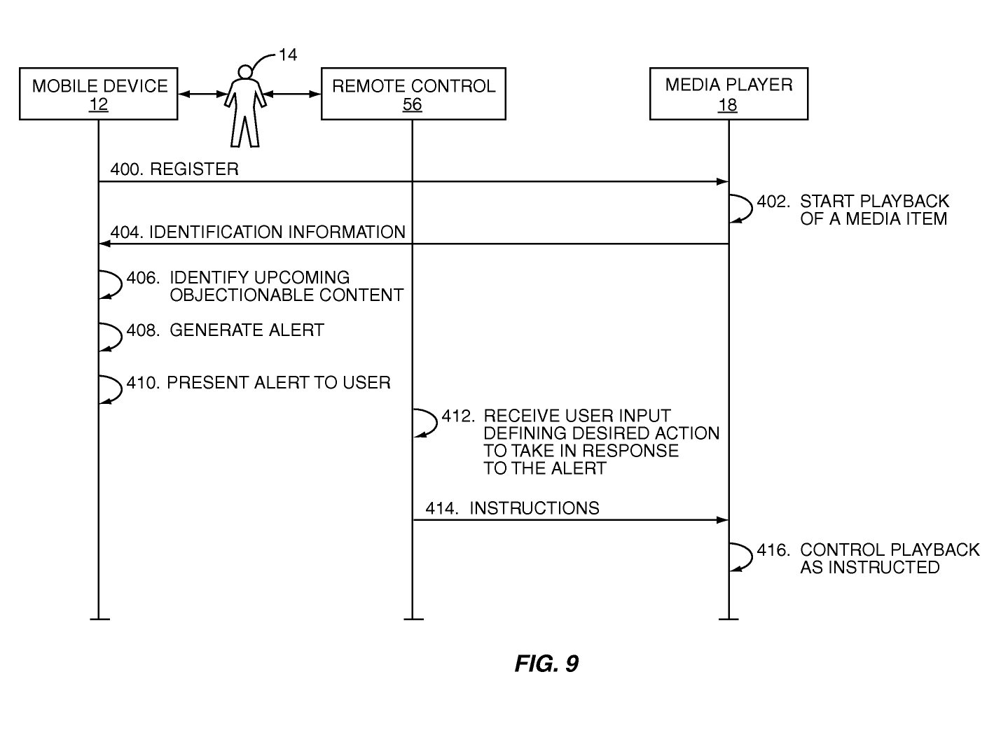

FIG. 9 illustrates the operation of the advance content alert system 44 of FIG. 4 according to one embodiment of the present invention. First, the mobile device 12 registers with the media player 18 (step 400). During registration, communication between the mobile device 12 and the media player 18 is established. Note that any personalized configurations for advance content alerts are stored and utilized by the mobile device 12 of the user 14.

In this embodiment, the media player 18 then begins playback of a media item (step 402). The media item is preferably a video item such as a television program, movie, or the like. However, the media item may alternatively be an audio item such as a song, audio book, radio broadcast, podcast, or the like. As discussed above, sometime either prior to or during playback of the media item, the media player 18 provides information identifying the media item to the mobile device 12 (step 404). Based on the identification information, the mobile device 12 obtains metadata for the media item. In addition to the identification information, as discussed above, the media player 18 may provide timing information to the mobile device 12 identifying a playback position within the media item.

The alert generation and presentation function 52 of the mobile device 12 then identifies upcoming objectionable content based on the metadata (step 406). In one embodiment, once the media item is identified based on the identification information, the alert generation and presentation function 52 obtains metadata for the media item from the content metadata source 30 and processes the metadata to identify upcoming objectionable content as defined by the personalized configurations of the user 14. Note that the alert generation and presentation function 52 may alternatively provide the identification information to the content metadata source 30, where the content metadata source 30 identifies the media item and returns the metadata for the media item to the alert generation and presentation function 52. The manner in which the alert generation and presentation function 52 identifies upcoming objectionable content based on the metadata for the media item is the same as discussed above with respect to the alert generation function 26 and, as such, the details are not repeated.

After identifying upcoming objectionable content, the alert generation and presentation function 52 generates an advance content alert for the upcoming objectionable content (step 408). The advance content alert may be generated to include information describing the objectionable content or the like. In addition, a preview of the objectionable content may be obtained from the media player 18 or a remote source such as, for example, a media distribution service. For example, if the objectionable content is violence and the media item is a video, a preview of the video including all or a portion of the violent content may be obtained and included in the advance content alert. In addition or alternatively, the advance content alert may include all or a portion of any annotation for the upcoming objectionable content, information identifying the objectionable content as violent content, a count-down timer indicating an amount of time, such as a number of seconds, until playback of the upcoming objectionable content, or the like.

If the user 14 has defined personalized configurations defining desired attributes of advance content alerts, the alert generation and presentation function 52 generates the advance content alert for the upcoming objectionable content according to those desired attributes. For example, if the user 14 desires that the alert be given a defined amount of time before the objectionable content is to be played, the alert generation and presentation function 52 generates the alert at a time that will enable the alert to be presented to the user 14 at the mobile device 12 at the desired time.

After generating the advance content alert, the alert generation and presentation function 52 presents the advance content alert to the user 14 at the mobile device 12 (step 410). Preferably, the advance content alert is presented to the user 14 via a display of the mobile device 12. However, the advance content alert may alternatively be an audible alert, a vibration alert, or the like in which case the alert processing function 22 operates to present the advance content alert to the user 14 accordingly. Further, if the personalized configurations of the user 14 define a desired amount of time prior to the objectionable content that the advance content alert is to be presented, the alert generation and presentation function 52 presents the advance content alert at the desired time.

Next, the remote control 56 receives user input from the user 14 defining a desired action to take in response to the advance content alert (step 412). The user input may be used to select traditional remote control functions such as muting playback, fast-forwarding, skipping, or the like. Upon receiving the user input from the user 14, the remote control 56 sends corresponding instructions to the media player 18 (step 414). In this embodiment, the instructions from the remote control 56 may be traditional remote commands. Note that the advance content alert may provide an indication as to the time at which the objectionable content occurs in playback of the media item. Using this information, the user 14 may mute, fast-forward, skip scenes, or the like at the appropriate time. The media playback function 24 of the media player 18 then controls playback of the media item as instructed by the user 14 via the remote control 56 (step 416).

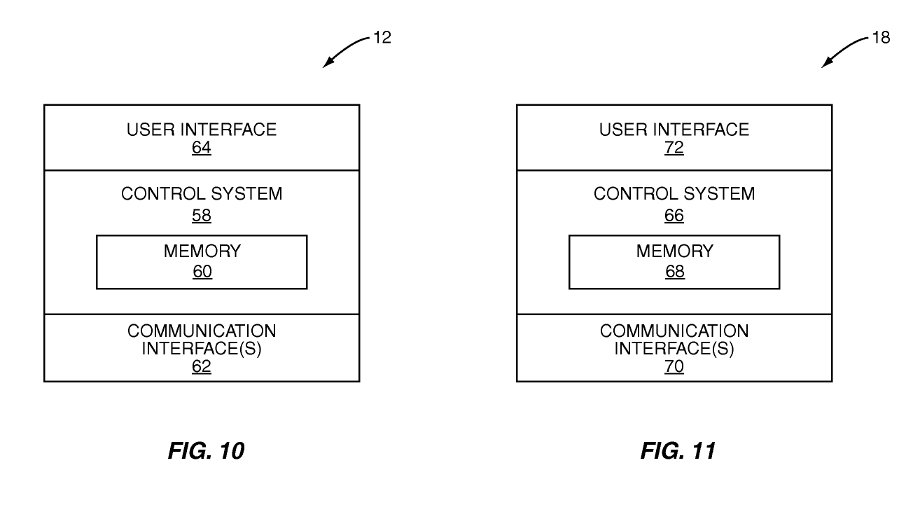

FIG. 10 is a block diagram of the mobile device 12 according to one embodiment of the present invention. As illustrated, the mobile device 12 includes a control system 58 having associated memory 60. Depending on the embodiment, the alert processing function 22 (FIGS. 1 and 4) or the alert generation and presentation function 52 (FIGS. 6 and 8) are implemented in software and stored in the memory 60. However, the present invention is not limited thereto. The alert processing function 22 may be implemented in software, hardware, or a combination thereof. Likewise, the alert generation and presentation function 52 may be implemented in software, hardware, or a combination thereof. The mobile device 12 also includes one or more communication interfaces 62 communicatively coupling the mobile device 12 to the media player 18 (FIGS. 1 and 4) or both the media player 12 and the content metadata source 30 (FIGS. 6 and 8). Lastly, the mobile device 12 includes a user interface 64, which may include a display, one or more speakers, one or more user input devices, or the like.

FIG. 11 is a block diagram of the media player 18 according to one embodiment of the present invention. As illustrated, the media player 18 includes a control system 66 having associated memory 68. Depending on the embodiment, the media playback function 24 and the alert generation function 26 (FIG. 1), the media playback function 24, the alert generation function 26, and the control interpretation function 48 (FIG. 4), or the media playback function 24 (FIGS. 6 and 8) are implemented in software and stored in the memory 68. However, the present invention is not limited thereto. Each of the media playback function 24, the alert generation function 26, and the control interpretation function 48 may be implemented in software, hardware, or a combination thereof. The media player 18 also includes one or more communication interfaces 70 communicatively coupling the media player 18 to the mobile device 12. In addition, depending on the embodiment, the one or more communication interfaces 70 may communicatively couple the media player 18 to one or more of the content source 28 and the content metadata source 30 depending on the particular embodiment. The one or more communication interfaces 70 may also include an interface for receiving commands from the remote control 56 (FIG. 8). Lastly, the media player 18 includes a user interface 72, which may include a display, one or more buttons or other user input devices, or the like.

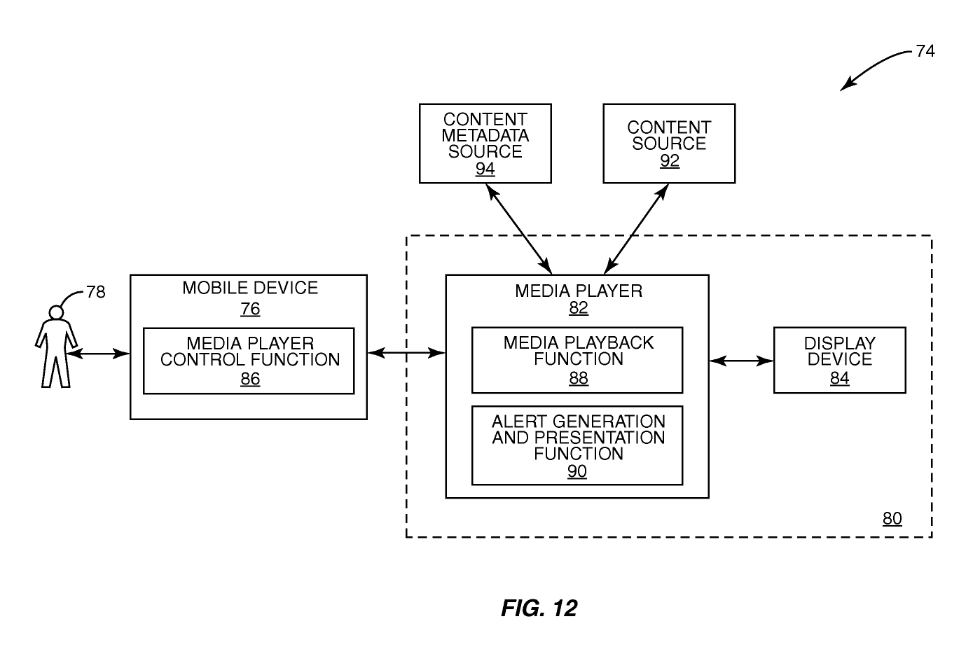

FIGS. 1 through 11 discuss advance content alert systems 10, 44, 50, and 54 for providing advance content alerts to the mobile device 12 of the user 14. FIG. 12 illustrates an advance content alert system 74 for inserting advance content alerts, which are preferably unobtrusive advance content alerts, into a media item during playback according to one embodiment of the present invention. In general, the advance content alert system 74 includes a mobile device 76 having an associated user 78 and a media playback system 80. In this embodiment, the media playback system 80 includes a media player 82 and a display device 84. The mobile device 76 may be, for example, a mobile telephone such as the Apple® iPhone, a portable media player such as the Apple® iPod® Touch, or the like. The mobile device 76 is preferably connected to the media player 82 via a local wireless connection such as, for example, a Bluetooth® connection, an IEEE 802.11 connection, or the like. However, the mobile device 76 may be connected to the media player 82 via any type of wireless connection provided via any type or combination of WAN, LAN, PAN, or the like. In this embodiment, the mobile device 76 includes a media player control function 86. The media player control function 86 may be implemented in software, hardware, or a combination thereof. The media player control function 86 operates to control the media player 82 to take a desired action in response to an advance content alert inserted into a media item during playback.

The media player 82 may be, for example, a STB for playing digital television content received from a television content provider, a DVR for playing previously recorded video content such as previously recorded television content received from a television content provider, an Apple TV® device for playing downloaded content that has been purchased or rented from a remote media distribution service such as the Apple® iTunes® store, a DVD player, a personal computer, or the like. The media player 82 may be connected to the display device 84 via any desired audio/video connection such as, for example, a HDMI connection, a DVI connection, a coaxial cable connection, or the like. The display device 84 may be, for example, a television. Alternatively, the display device 84 may be incorporated into the media player 82.

The media player 82 includes a media playback function 88 and an alert generation and presentation function 90, each of which may be implemented in software, hardware, or a combination thereof. The media playback function 88 generally operates to provide playback of media items obtained from a content source 92. In the preferred embodiment, the media items are video items. As such, the media playback function 88 provides playback of the video items and presentation of the video items to the user 78 and any other nearby users via the display device 84. The content source 92 varies depending on the particular implementation of the media player 82. For example, if the media player 82 is a STB, then the content source 92 may be a television content distribution network such as a CATV network. As another example, if the media player 82 is a DVD player, then the content source 92 is a DVD. As a final example, if the media player 82 is a device such as an Apple TV® device, then the content source 92 may be a remote media distribution service such as the Apple® iTunes® store, where the media player 82 has access to the remote media distribution service via a network such as, for example, the Internet.

As discussed below, the alert generation and presentation function 90 generally operates to identify content in a media item for which advance content alerts are desired by the user 78 and insert advance content alerts into the media item during playback. The content for which the user 78 desires advance content alerts is preferably objectionable content such as profane language, violent content, sexual situations, or the like. As such, the content for which the user 78 desires advance content alerts is hereinafter referred to an objectionable content. However, the present invention is not limited thereto.

In one embodiment, either prior to or during playback of a media item, the alert generation and presentation function 90 obtains metadata for the media item from a content metadata source 94 and identifies objectionable content in the media item based on the metadata. As discussed above, the metadata may be tags directly identifying potentially objectionable content in the media item, annotations provided by the user 78, other users that have consumed (i.e., viewed, listened to, etc.) the media item, or a producer of the media item, a script if the media item is a video item such as a movie or television program, lyrics if the media item is a song, closed-captioning information, subtitles, or the like.

The content metadata source 94 may vary depending on the particular implementation. In one embodiment, if the media item is provided according to a standard allowing for annotations such as MPEG-7, the content metadata source 94 may be the same as that of the media item where the annotations are provided in connection with the media item according to the standard. Similarly, if the media item has closed-captioning or subtitles, the content metadata source 94 may be the same as that of the media item. Alternatively, the content metadata source 94 may be a remote server storing metadata for a number of media items, where the alert generation and presentation function 90 queries the remote server to obtain the metadata for the media item. Note, however, that the content metadata source 94 may be any source of metadata that may be used to directly or indirectly identify objectionable content in the media item. Again, the present invention is not limited to detecting objectionable content based on metadata for the media item. For example, rather than identifying the objectionable content based on metadata for the media item, the alert generation and presentation function 90 may alternatively analyze the media content of the media item to identify the objectionable content.

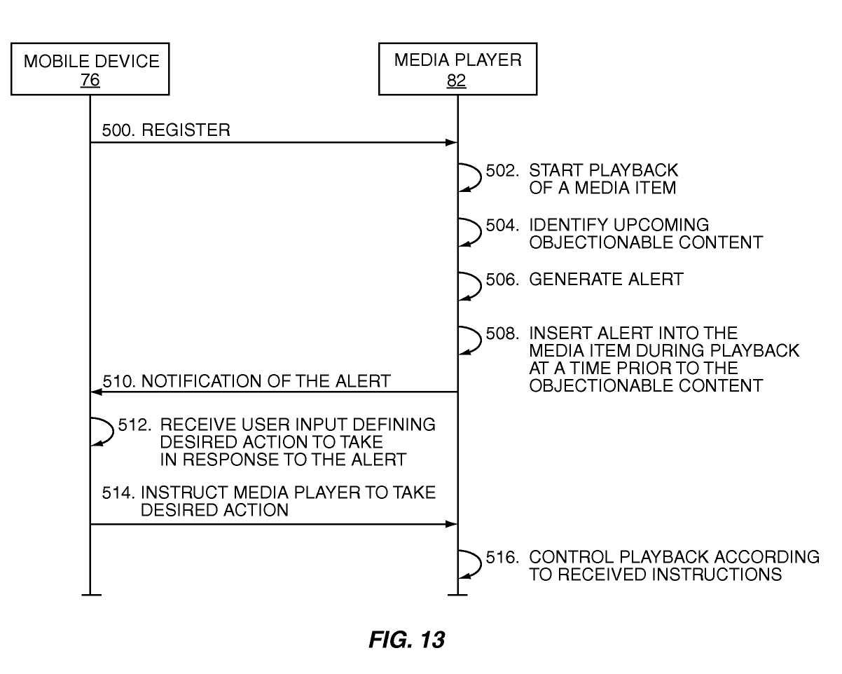

FIG. 13 illustrates the operation of the advance content alert system 74 of FIG. 12 according to one embodiment of the present invention. First, the mobile device 76 registers with the media player 82 (step 500). During registration, communication between the mobile device 76 and the media player 82 is established. In addition, the user 78 of the mobile device 76 may be enabled to provide personalized configurations to the alert generation and presentation function 90 for advance content alerts to be provided to the user 78. The personalized configurations may include types of content for which the user 78 desires to receive advance content alerts. In one embodiment, the user 78 is enabled to select one or more types of objectionable content for which to receive alerts from a list of predefined objectionable content types such as, for example, profane language, violent content, scary content, sexual situations, or the like. In addition or alternatively, the user 78 may be enabled to define customized objectionable content types by, for example, entering one or more keywords, selecting one or more keywords from a list of predefined keywords, or the like. In an alternative embodiment, the types of objectionable content may be predefined and non-configurable by the user 78.

In addition to defining the types of objectionable content, the personalized configurations of the user 78 may define desired attributes of the advance content alerts. The desired attributes may include, for example, an amount of time between when an advance content alert is to be inserted in the media item during playback and the occurrence of the objectionable content. The desired attributes may also include attributes defining a form of the advance content alert. If the media item is a video item, the form may be a graphic that is to be overlaid onto or inserted into the frames of the media item, text that is to be overlaid onto or inserted into the frames of the media item, an audible sound inserted into an audio component of the video item, or the like. In addition, the desired attributes may include a desired position in which the advance content alert is to be inserted in the frames of the video item, a size of the advance content alert, a loudness of the advance content alert, a color of the advance content alert, or the like. Still further, the desired attributes may define how the advance content alert is to dynamically change as playback of objectionable content becomes nearer in time. Note that different attributes may be defined for each objectionable content type such that the user 78 is enabled to quickly ascertain the type of objectionable content that is upcoming, thereby enabling the user 78 to quickly determine the type of upcoming objectionable content based on the attributes of the advance content alert.

As an example, advance content alerts may take the form of a fly that is overlaid upon or otherwise inserted into frames of a video item during playback. The color or position of the fly may be indicative of the type of objectionable content. Still further, the size and/or buzzing sound produced by the fly may increase as playback of the objectionable content approaches.

As another example, the advance content alerts may be provided as text appearing at the top or bottom of the frames of the video item. The text may preferably be indicative of the type of objectionable content. The text may actually state the type of objectionable content. Alternatively, code words or phrases may be used such that the text does not actually state that, for example, profanity, nudity, violence, or the like is upcoming. However, whatever text that is used would be understood by the user 78 as being an advance content alert and may further be understood by the user 78 as being an advance content alert for a particular type of objectionable content.

Note that the exemplary embodiments of the advance content alerts given above are not intended to limit the scope of the present invention. Numerous variations will be apparent to one of ordinary skill in the art upon reading this disclosure. Also note that the advance content alerts inserted into media items are preferably unobtrusive in that the advance content alerts inserted into media items do not affect, or do not substantially affect, the viewing or listening experience of the user 78 or other nearby users. Still further, it is also preferable that the advance content alerts inserted into media items are not understood by the nearby viewers or listeners, such as children of the user 78, as being advance content alerts.

The personalized configurations may also include configurations defining when advance content alerts are to be provided to the user 78. More specifically, the personalized configurations may define a time period during the day when the advance content alerts are or are not to be provided, one or more days of the week on which the advance content alerts are or are not to be provided, or the like. For example, the personalized configurations may be defined such that advance content alerts are provided only during the hours of 5 PM to 9 PM when it is likely that the user 78 and his children will be viewing or listening to media items played by the media player 82. The personalized configurations may also be defined such that the advance content alerts are only to be provided when another defined user, or mobile device of another defined user, is nearby, such as within a local wireless communication range of the media player 82. For example, the user 78 may register a mobile device of his child with the media player 82 and define his personalized configurations such that advance content alerts are provided only when the mobile device of his child is within a local wireless communication range of the media player 82. Still further, the personalized configurations may include configurations defining an amount of time that the alert generation and presentation function 90 is to look ahead into the media item to look for objectionable content. For example, the personalized configurations may state that the media player 82 is to look ahead ten (10) minutes for upcoming content for which the user 78 desires advance content alerts.

In this embodiment, the media player 82 then begins playback of a media item (step 502). The media item is preferably a video item such as a television program, movie, or the like. However, the media item may alternatively be an audio item such as a song, audio book, radio broadcast, podcast, or the like. Next, the media player 82, and more specifically the alert generation and presentation function 90, identifies upcoming objectionable content (step 504). More specifically, in one embodiment, the alert generation and presentation function 90 obtains metadata for the media item from the content metadata source 94 and processes the metadata to identify upcoming objectionable content as defined by the personalized configurations of the user 78, as discussed above with respect to the alert generation function 26. As such, the details are not repeated.

Again, as discussed above, the manner in which the metadata for the media item is obtained may vary depending on the particular implementation. The metadata may be provided to the media player 82 in association with the media item. Alternatively, the metadata may be obtained from a remote source such as a remote server storing metadata for a number of media items including the media item. Also, it should be noted that the present invention is not limited to identifying objectionable content in the media item based on metadata for the media item. For example, as discussed above, rather than identifying the objectionable content based on metadata for the media item, the alert generation and presentation function 90 may analyze the media item itself to identify the content for which the advance content alerts are desired.

After identifying upcoming objectionable content, the alert generation and presentation function 90 generates an advance content alert for the upcoming objectionable content (step 506) and inserts the advance content alert into the media item during playback prior to the upcoming objectionable content (step 508). If the user 78 has defined personalized configurations defining desired attributes of advance content alerts and the timing of the advance content alerts, the alert generation and presentation function 90 generates the advance content alert and inserts the advance content alert into the media item according to the personalized configurations of the user 78. For example, if the user 78 desires that the alert be given a defined amount of time before the objectionable content is to be played, the advance content alert is generated and inserted into the media item during playback at the desired time. Optionally, the alert generation and presentation function 90 of the media player 82 may provide a notification of the advance content alert to the mobile device 76 of the user 78 (step 510). The notification may result in, for example, the mobile device 76 beeping or vibrating to notify the user 78 of the presence of the advance content alert.

In this embodiment, in response to the advance content alert inserted into the media item during playback, the media player control function 86 of the mobile device 76 receives user input from the user 78 defining a desired action to be taken in response to the advance content alert (step 512). In one embodiment, the media player control function 86 provides traditional remote control functionality such as instructing the media player 82 to mute playback, fast-forward playback, or the like. As such, the user 78 may, for example, mute playback of the media item when the advance content alert indicates that profane language is imminent, fast-forward when the advance content alert indicates that violent content is imminent, or the like. In another embodiment, the media player control function 86 may enable the user 78 to select a desired action to take from a list actions. For example, the notification provided in step 510 may also include the type of objectionable content that is upcoming. In response, the media player control function 86 may present a corresponding list of actions that may be taken by the user 78. For instance, if the objectionable content is profane language, the list of actions may include “bleeping out” the profane language, muting playback during the profane language, replacing the profane language with substitute words, or the like. Note that the synchronization of these desired actions to the profane language is provided by the metadata. As an alternative, the notification provided in step 510 may include a list of actions that may be taken by the user 78 via the mobile device 76.

Likewise, if the media item is a video and the objectionable content is a segment of the video including violence, nudity, or the like, the list of actions may include skipping the objectionable content, skipping to a next most similar frame, replacing the objectionable content with an advertisement, or the like. When skipping the objectionable content, the media player 82 may provide for skipping a predefined amount of time. Alternatively, the metadata may be used to identify the beginning and end of the objectionable content such that the user 78 is enabled to skip from the start of the objectionable content to the end of the objectionable content. As for skipping to the next most similar frame, the media player 82 may perform frame analysis to identify a next most similar frame to a frame at the beginning of or prior to the objectionable content. The user 78 may then be enabled to skip from the frame at the beginning of or prior to the objectionable content to the next most similar frame.

Upon receiving the user input from the user 78, the mobile device 76 instructs the media player 82 to perform the desired action (step 514). In response, the media player 82, and more specifically the media playback function 88 of the media player 82, controls playback of the media item according to the received instructions such that the desired action is taken (step 516).

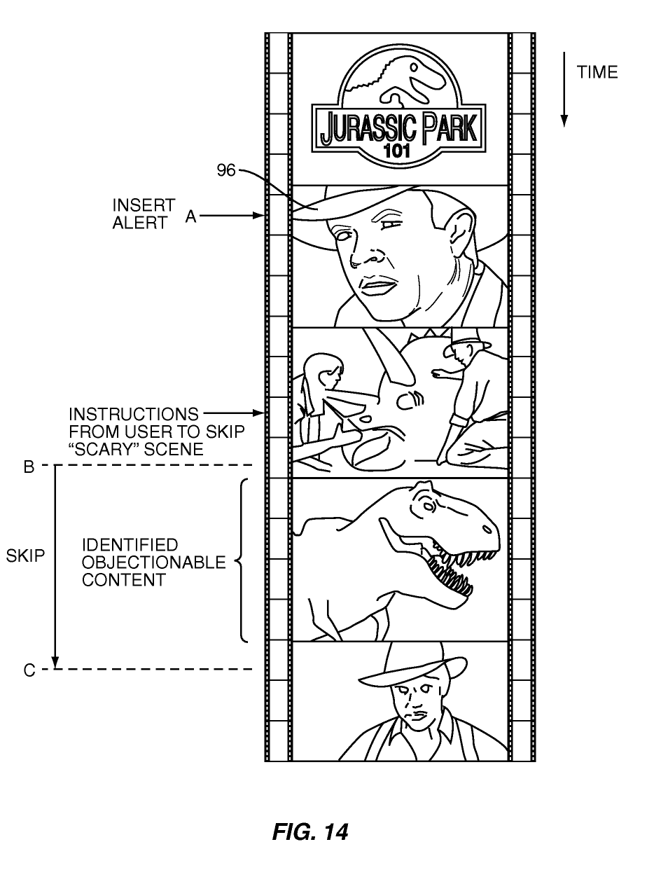

FIG. 14 graphically illustrates an exemplary advance content alert inserted into a media item and skipping over the corresponding objectionable content in response to instructions from the user 78 according to one embodiment of the present invention. Note that FIG. 14 illustrates an abbreviated frame sequence of a video item. As illustrated, objectionable content is identified. In this example, the objectionable content is a segment of the video content item that is identified as being scary. As a result, an advance content alert 96 is inserted at point A during playback of the media item. In this example, the advance content alert 96 is a fly inserted in the top left corner of the frames of the video item beginning at point A. Note that the location within the frames of the video content in which the fly is inserted may be selected based on a frame analysis process. The frame analysis process may identify the most desirable location within the frames of the video content preceding the objectionable content in which to insert the fly. For example, the frame analysis process may identify a location within the frames that is essentially unused. As another example, the frame analysis process may take into account the coloring, size, shape, and other visual characteristics of the fly and select an appropriate location within the frames preceding the objectionable content in which to insert the fly. Note that as playback approaches the identified objectionable content, the fly may be dynamically modified by, for example, increasing the size of the fly, changing the color of the fly, increasing the loudness of an associated buzzing sound, making the fly blink such that the intensity of the blinking increases as the objectionable content approaches, or the like. At some point thereafter, instructions are received from the user 78 to skip the “scary” content. As a result, when playback reaches a point B, playback skips to a point C, thereby skipping over the “scary” content.

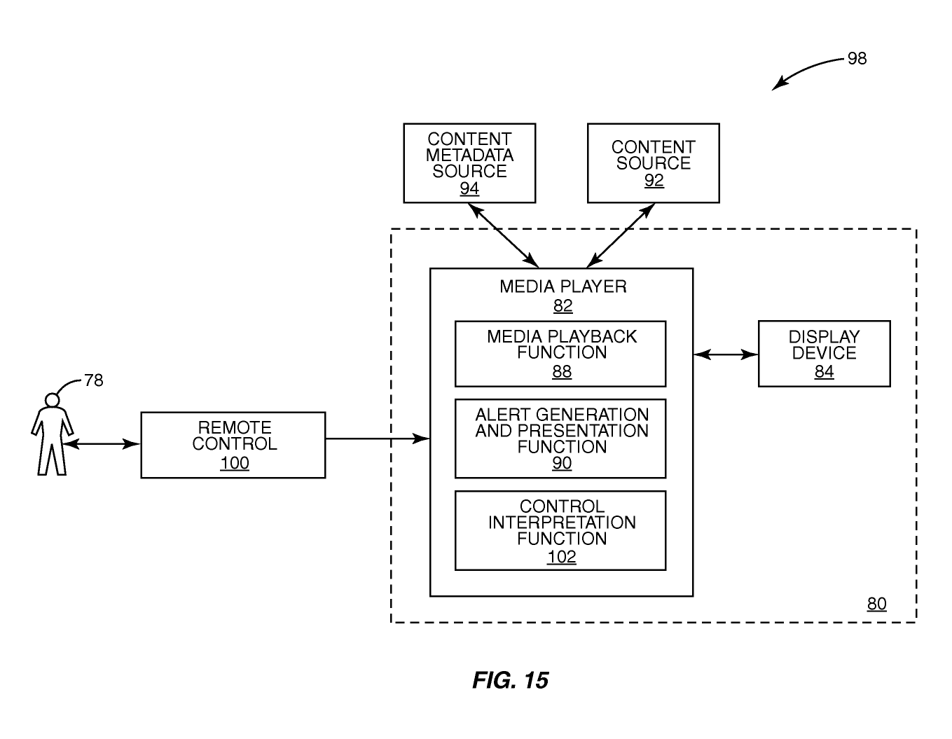

FIG. 15 illustrates an advance content alert system 98 for inserting unobtrusive advance content alerts into a media item during playback according to another embodiment of the present invention. The advance content alert system 98 is substantially the same as the advance content alert system 74 of FIGS. 12 and 13. However, in this embodiment, the user 78 is enabled to take a desired action in response to an advance content alert inserted into a media item during playback via a remote control 100 of the media player 82. In addition, the media player 82 may include a control interpretation function 102 for interpreting instructions or commands from the remote control 100 received by the media player 82 in response to an advance content alert.

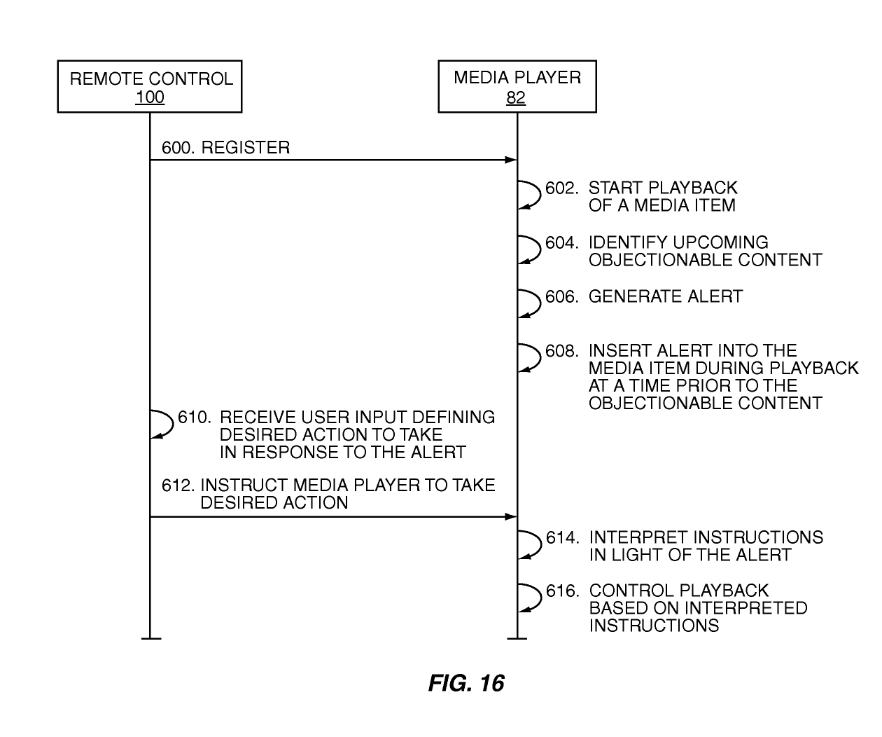

FIG. 16 illustrates the operation of the advance content alert system 98 of FIG. 15 according to one embodiment of the present invention. First, in this exemplary embodiment, the user 78 registers with the media player 82 to receive advance content alerts via, for example, the remote control 100 (step 600). During registration, the user 78 of the mobile device 76 may be enabled to provide personalized configurations to the alert generation and presentation function 90 for advance content alerts to be provided to the user 78, as discussed above. In this embodiment, the media player 82 then begins playback of a media item (step 602). The media item is preferably a video item such as a television program, movie, or the like. However, the media item may alternatively be an audio item such as a song, audio book, radio broadcast, podcast, or the like.

Next, the media player 82, and more specifically the alert generation and presentation function 90, identifies upcoming objectionable content (step 604). More specifically, in one embodiment, the alert generation and presentation function 90 obtains metadata for the media item from the content metadata source 92 and processes the metadata to identify upcoming objectionable content as defined by the personalized configurations of the user 78, as discussed above. Again, as discussed above, the manner in which the metadata for the media item is obtained may vary depending on the particular implementation. Also, as discussed above, the present invention is not limited to identifying objectionable content in the media item based on metadata for the media item.

After identifying upcoming objectionable content, the alert generation and presentation function 90 generates an advance content alert for the upcoming objectionable content (step 606) and inserts the advance content alert into the media item during playback prior to the upcoming objectionable content (step 608). If the user 78 has defined personalized configurations defining desired attributes of advance content alerts and the timing of the advance content alerts, the alert generation and presentation function 90 generates the advance content alert and inserts the advance content alert into the media item according to the personalized configurations of the user 78.

Note that while not illustrated, in another embodiment, a list of actions that may be taken by the user 78 in response to the advance content alert via the remote control 100 may be presented to the user 78 at a mobile device of the user 78, such as the mobile device 76 (FIG. 12). The list of actions may be presented in response to a notification of the advance content alert provided from the media player 82 to the mobile device 76 of the user 78. For example, for each type of objectionable content, the mobile device 76 may store a predetermined list of actions that may be taken in response to advance content alerts for objectionable content of that type. Alternatively, the notification may include the list of actions that may be taken by the user 78 via the remote control 100.

In this embodiment, in response to the advance content alert inserted into the media item during playback, the remote control 100 receives user input from the user 78 defining a desired action to be taken in response to the advance content alert (step 610). Upon receiving the user input from the user 78, the remote control 100 sends corresponding instructions to the media player 82 (step 612). Optionally, the control interpretation function 102 interprets the instructions from the remote control 100 in light of the advance content alert inserted into the media item (step 614). For example, if the objectionable content is profane language, a mute instruction or command from the remote control 100 may be interpreted as instructions to mute the profane language, “bleep out” the profane language, replace the profane language with substitute words, or the like. As another example, if the objectionable content is violent content, a fast-forward command or skip command may be interpreted as an instruction to skip the violent content, skip to a next most similar frame, or the like. Alternatively, the instruction from the remote control 100 may not be interpreted. The media playback function 88 of the media player 82 then controls playback of the media item according to the interpreted instructions from the remote control 100, or alternatively non-interpreted instructions from the remote control 100, such that the desired action selected by the user 78 is taken (step 616).

It should be noted that the advance content alerts inserted into the media item as discussed with respect to FIGS. 12 through 15 and the advance content alerts provided to the mobile device 12 of the user as discussed with respect to FIGS. 1 through 9 may be used in combination. For example, in one embodiment, in addition to inserting an advance content alert into the media item during playback, the media player 82 may also provide an advance content alert to the mobile device 76 of the user 78 in the manner described above with respect to FIGS. 1 through 9.

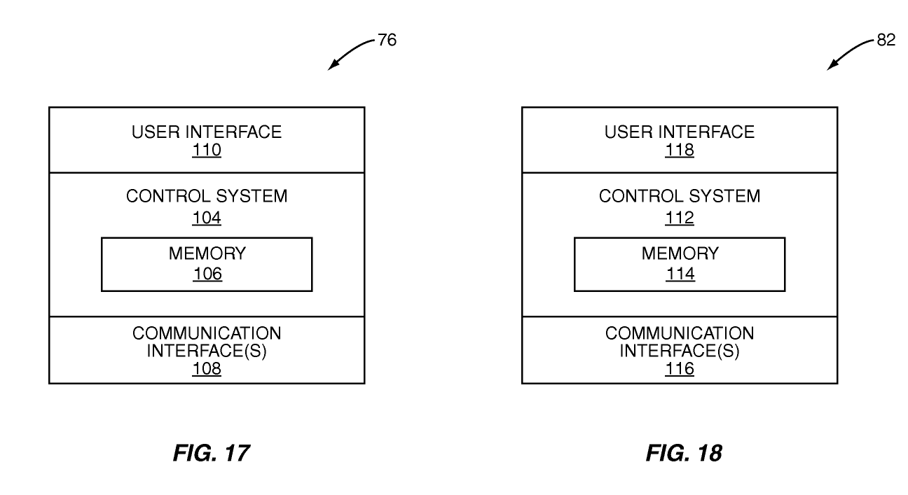

FIG. 17 is a block diagram of the mobile device 76 according to one embodiment of the present invention. As illustrated, the mobile device 76 includes a control system 104 having associated memory 106. In one embodiment, the media player control function 86 is implemented in software and stored in the memory 106. However, the present invention is not limited thereto. The media player control function 86 may be implemented in software, hardware, or a combination thereof. The mobile device 76 also includes one or more communication interfaces 108, one of which communicatively couples the mobile device 76 to the media player 82. Lastly, the mobile device 76 includes a user interface 110, which may include a display, one or more speakers, one or more user input devices, or the like.

FIG. 18 is a block diagram of the media player 82 according to one embodiment of the present invention. As illustrated, the media player 82 includes a control system 112 having associated memory 114. Depending on the embodiment, the media playback function 88 and the alert generation and presentation function 90 (FIG. 12) or the media player function 88, the alert generation and presentation function 90, and the control interpretation function 102 (FIG. 15) are implemented in software and stored in the memory 114. However, the present invention is not limited thereto. Each of the media playback function 88, the alert generation and presentation function 90, and the control interpretation function 102 may be implemented in software, hardware, or a combination thereof. The media player 82 also includes one or more communication interfaces 116 communicatively coupling the media player 82 to one or more of the mobile device 76, the content source 92, the content metadata source 94, and the remote control 100 depending on the particular embodiment. Lastly, the media player 82 includes a user interface 118, which may include a display, one or more buttons or other user input devices, or the like.

The present invention has substantial opportunity for variation without departing from the spirit or scope of the present invention. For example, while the embodiments discussed herein are directed to personal or in-home playback systems, the present invention is not limited thereto. For example, the present invention may also be implemented in a public playback system such as, for example, a movie theater. However, in such an embodiment, the user 14, 78 may not be enabled to control playback. As another example, while control of playback in response to advance content alerts has been discussed herein as occurring at the media player 18, 82, the present invention is not limited thereto. More specifically, if the media item being presented to the user 14, 78 is, for example, a streaming video, then a desired action selected by the user 14, 78 to be taken in response to an advance content alert may be performed by controlling playback or streaming of the media item at its source, which may be a streaming content server or the like.

Those skilled in the art will recognize improvements and modifications to the preferred embodiments of the present invention. All such improvements and modifications are considered within the scope of the concepts disclosed herein and the claims that follow.

What is claimed is:

1. A method of operation of a media player comprising:
providing playback of a media item;
detecting upcoming content for which a user associated with the media player has requested an advance content alert; and
generating the advance content alert for alerting the user of the upcoming content; and
inserting the advance content alert into the media item during playback such that the advance content alert is presented to the user prior to playback of the upcoming content.

2. The method of claim 1 wherein the upcoming content for which the user desires the advance content alert is objectionable content in the media item.

3. The method of claim 1 wherein the upcoming content for which the user desires the advance content alert is desirable content in the media item.

4. The method of claim 1 wherein detecting the upcoming content for which the user desires the advance content alert comprises:
obtaining metadata describing media content of the media item; and
detecting the upcoming content based on the metadata.

5. The method of claim 4 wherein the user desires advance content alerts for at least one type of content, and the metadata comprises information directly identifying each occurrence of the at least one type of content in the media item.

6. The method of claim 4 wherein the metadata comprises annotations, and detecting the upcoming content based on the metadata comprises detecting the upcoming content based on the annotations.

7. The method of claim 4 wherein the metadata comprises a script of the media item, and detecting the upcoming content based on the metadata comprises detecting the upcoming content based on the script.

8. The method of claim 4 wherein the media item is a song and the metadata comprises lyrics of the song, further wherein detecting the upcoming content based on the metadata comprises detecting the upcoming content based on the lyrics.

9. The method of claim 1 wherein detecting the upcoming content for which the user desires the advance content alert comprises analyzing media content of the media item to detect the upcoming content for which the user desires the advance content alert.

10. The method of claim 1 wherein the advance content alert is unobtrusive.

11. The method of claim 1 wherein the advance content alert comprises at least one element from a group consisting of: a graphic, text, and a sound.

12. The method of claim 1 wherein the media item is a video item, the advance content alert comprises at least a visual component, and inserting the advance content alert comprises:
performing a frame analysis of the video item to identify a desired location within frames of the video item prior to the upcoming content in which to insert the visual component of the advance content alert; and
inserting the visual component of the advance content alert into the frames of the video item prior to the upcoming content at the desired location within the frames.

13. The method of claim 1 wherein the user desires to receive advance content alerts for at least one type of objectionable content, and the advance content alert is indicative of a type of objectionable content from the at least one type of objectionable content for the upcoming content.

14. The method of claim 1 wherein the advance content alert is indicative of a closeness in time of the upcoming content in the playback of the media item.

15. The method of claim 1 wherein inserting the advance content alert comprises dynamically modifying at least one attribute of the advance content alert as playback of the media item proceeds such that the advance content alert is indicative of a closeness in time of the upcoming content in the playback of the media item.

16. The method of claim 1 wherein at least one attribute of the advance content alert is configurable by the user.

17. The method of claim 1 further comprising providing, to a mobile device of the user, a list of one or more actions that may be taken by the user in response to the advance content alert via the mobile device.

18. The method of claim 17 further comprising:
receiving instructions from the mobile device defining a desired action from the list of one or more actions selected by the user at the mobile device; and
controlling playback of the media item according to the instructions from the mobile device.

19. The method of claim 1 further comprising providing a notification of the advance content alert to a mobile device of the user, wherein in response to the notification the mobile device presents a list of one or more actions that may be taken by the user in response to the advance content alert to the user.

20. The method of claim 19 further comprising:
receiving instructions from the mobile device defining a desired action from the list of one or more actions selected by the user at the mobile device; and
controlling playback of the media item according to the instructions from the mobile device.

21. The method of claim 1 further comprising providing, to a mobile device of the user, a list of one or more actions that may be taken by the user in response to the advance content alert via a remote control of the media player.

22. The method of claim 21 further comprising:
receiving a command from the remote control in response to input from the user at the remote control;
interpreting the command in light of the advance content alert to determine a desired action to be taken; and
controlling playback of the media item to perform the desired action.

23. The method of claim 1 further comprising providing a notification of the advance content alert to a mobile device of the user, wherein in response to the notification the mobile device presents a list of one or more actions that may be taken by the user in response to the advance content alert via a remote control of the media player.

24. The method of claim 23 further comprising:
receiving a command from the remote control in response to input from the user at the remote control;
interpreting the command in light of the advance content alert to determine a desired action to be taken; and
controlling playback of the media item to perform the desired action.

25. The method of claim 1 further comprising:
receiving instructions from a mobile device of the user defining a desired action, selected by the user, to be taken in response to the advance content alert; and
controlling playback of the media item according to the instructions from the mobile device.

26. The method of claim 1 further comprising:
receiving a command from a remote control of the media player defining a desired action, selected by the user, to be taken in response to the advance content alert; and
controlling playback of the media item according to the command.

27. The method of claim 1 further comprising:
receiving a command from a remote control of the media player defining a desired action, selected by the user, to be taken in response to the advance content alert;
interpreting the command in light of the advance content alert to determine a desired action to be taken; and
controlling playback of the media item to perform the desired action.

28. The method of claim 1 further comprising:
receiving personalized configurations from the user associated with the media player, the personalized configurations defining one or more types of content for which the user desires advance content alerts;
wherein detecting the upcoming content comprises detecting upcoming content in the media item corresponding to at least one of the one or more types of content defined by the personalized configurations of the user as the upcoming content for which the user desires the advance content alert.

29. The method of claim 28 wherein the personalized configurations further comprise at least one of a group consisting of: an amount of time ahead of a current time in playback of the media item that is to be processed to detect upcoming content for which the user desires an advance content alert, an amount of time prior to the upcoming content in playback of the media item that the user desires to receive the advance content alert, information defining at least one time of day during which advance content alerts are to be provided, information defining at least one time of day during which advance content alerts are not to be provided, information defining at least one day of the week on which advance content alerts are to be provided, information defining at least one day of the week on which advance content alerts are not to be provided, information identifying another user whose presence is required before advance content alerts are to be provided, information identifying a mobile device of another user that is required to be present before advance content alerts are to be provided, information identifying another user whose absence is required before advance content alerts are to be provided, and information identifying a mobile device of another user that is required to be absent before advance content alerts are to be provided; and
detecting the upcoming content, generating the advance content alert, and inserting the advance content alert are performed according to the personalized configurations of the user.

30. The method of claim 1 wherein the media item is one of a group consisting of: a video item and an audio item.

31. The method of claim 1 wherein inserting the advance content alert comprises inserting the advance content alert into the media item an amount of time prior to playback of the upcoming content that is sufficient to enable the user to take a desired action in response to the advance content alert.

32. The method of claim 1 wherein inserting the advance content alert comprises inserting the advance content alert into the media item at least five seconds prior to playback of the upcoming content.

33. A media player comprising:
a media playback function adapted to provide playback of a media item; and
an advance content alert and processing function adapted to:
detect upcoming content in the media item for which the associated user desires an advance content alert;
generate an advance content alert for alerting the associated user of the upcoming content; and
insert the advance content alert into the media item during playback by the media playback function such that the advance content alert is presented to the user prior to playback of the upcoming content.

34. A computer readable medium comprising software for instructing a media player to:
provide playback of a media item;
detect upcoming content in the media item for which a user associated with the media player desires an advance content alert;
generate an advance content alert for alerting the user of the upcoming content; and
insert the advance content alert into the media item during playback such that the advance content alert is presented to the user prior to playback of the upcoming content.
